(19) United States
(12) Patent Application Publication
(10) Pub. No.: US 2008/0174149 A1
(43) Pub. Date: Jul. 24, 2008

(54) STRUCTURAL INSULATION PANEL

(76) Inventors: Adrian R. Simms, Powell, OH (US); Keith Overton, Columbus, OH (US)

Correspondence Address: FITCH EVEN TABIN AND FLANNERY, 120 SOUTH LA SALLE STREET, SUITE 1600, CHICAGO, IL, 60603-3406, US

(21) Appl. No.: 11/624,429

(22) Filed: Jan. 18, 2007

(51) Int. Cl. B62D 33/06

(52) U.S. Cl. 296/190.02

(57) ABSTRACT

A structural insulation panel is provided for use with a truck or similar vehicle to provide structural support and thermal, acoustic, and vibration insulation. The structural insulation panel includes two fiberglass layers sandwiching and bonded to a foam core. The structural insulation panel may be used in the construction of truck cabs, sleeper boxes, roof caps, cab extenders, and other vehicle components.

### FIELD OF THE INVENTION

This invention relates to structural insulation panels, and more particularly, to structural insulation panels for use with truck cabs and sleeper boxes.

### BACKGROUND OF THE INVENTION

Trucking has long been used to transport cargo and other loads in interstate commerce. Trucks are commonly equipped with “sleeper” boxes, or modules, that are positioned directly behind the cab of the truck. These sleeper boxes may form one compartment with the cab or may form separate compartments. Drivers often use these sleeper boxes for rest or relaxation during a long, exhausting transport. In fact, drivers are required to rest for specific periods of time, pursuant to U.S. Department of Transportation regulations.

It is desirable to reduce the weight of the cabs and sleeper boxes as much as reasonably practicable. Reducing the weight of the cabs and sleeper boxes allows storage and hauling of additional payload in the trailer, resulting in a more economical transport. Also, reducing the weight of the cabs and sleeper boxes allows a cost savings in fuel consumption. In the past, cabs and sleeper boxes have been constructed primarily of sheet steel, aluminum, or other relatively heavy panels, which limit payload and waste fuel. Accordingly, there is a need to design and construct, at least in part, the cabs and sleeper boxes of lightweight panels to minimize the weight associated with the cabs and sleeper boxes.

It is also desirable to construct the cabs and sleepers of panels having thermal and acoustic properties that reduce the transfer of heat and noise through the panels. Generally, in order to reduce the transfer of heat, noise, and/or vibration, many panels used today are a combination of a number of separate structural attachments, secondary insulation panels, and other noise reduction components.

Currently, separate structural panels are often used in conjunction with insulation panels and noise reduction components. In other words, assemblies are used requiring a number of attachments and components that add to the overall cost of the panel. In general, a panel assembly may include three or more panels fastened together and performing various functions: a structural panel, an insulation panel, and an interior panel covered in some sort of trim material. Accordingly, there is a need to minimize the use of these multi-panel assemblies and replace them with single multi-purpose panels, as much as practicable, while limiting the required number of additional attachments and components, in order to reduce the cost of assembly.

Further, the need for panels with good insulating properties is becoming more pronounced in light of the recent passage of government regulations limiting the idling of trucks. It has been determined that idling wastes fuel and results in increased particulate emissions, maintenance costs, and noise concerns. As a result, the U.S. Environmental Protection Agency has adopted regulations to address and restrict idling, which it has determined to be a significant source of particulate emissions. A number of states and local jurisdictions have also adopted regulations to restrict idling. Truckers who sleep or rest in their cabs and sleepers, however, often idle their truck engines overnight to provide necessary heat for themselves. Thus, there is a need for a structural insulation panel that retains heat better and maintains the temperature in the cab or sleeper, thereby avoiding or limiting the need for idling.

Accordingly, a need exists for lightweight structural panels for use in truck cabs and sleepers. In addition, there is a need for strong panels that provide vibration, noise, and temperature insulation, thereby reducing the need for idling of truck engines. Further, there is a need for economical multi-purpose structural insulation panels to minimize the multi-panel assemblies currently used.

### BRIEF DESCRIPTION OF THE DRAWINGS

FIG. 1 is a perspective view of a structural insulation panel embodying features of the present invention;

FIG. 2 is a cross-sectional view of the structural insulation panel of FIG. 1;

FIG. 3 is a perspective view of a truck showing tractor and trailer and having portions of the tractor constructed of one or more structural insulation panels shown in FIG. 1; and

FIG. 4 is a partial cutaway view of the interior of the tractor of the truck shown in FIG. 3.

### DESCRIPTION OF THE PREFERRED EMBODIMENT

A preferred embodiment of a new lightweight structural insulation panel 10 embodying features of the present invention is described herein. The panel may be used in the construction of cabs, sleeper boxes, roof caps, cab extenders, and other truck components requiring one or more such structural insulation panels 10. The preferred embodiment adapts sandwich panel assembly technology for use with truck cabs, sleeper boxes, etc. Cabs and sleeper boxes have generally been constructed of multi-panel assemblies, such as structural panels, insulation panels, and trim panels. The preferred embodiment is a molded sandwich panel that replaces many of the components of these multi-panel assemblies with a single panel.

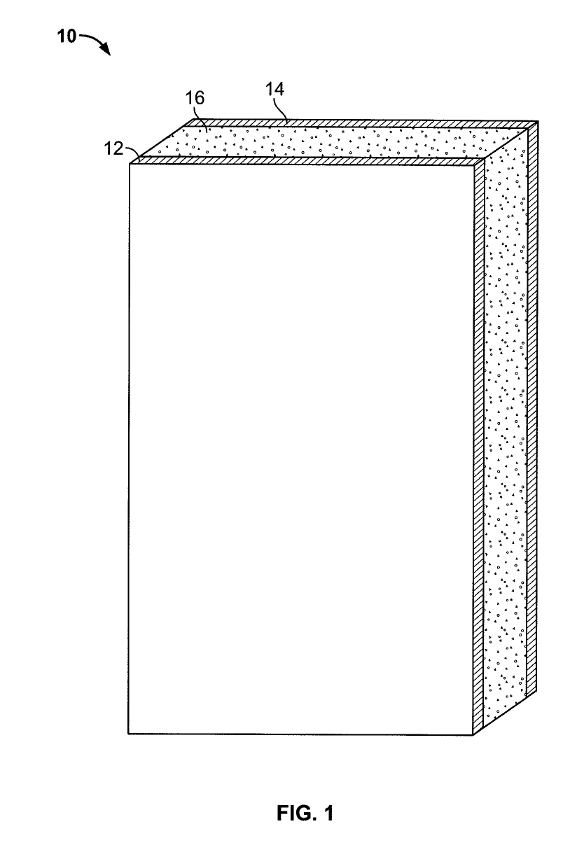

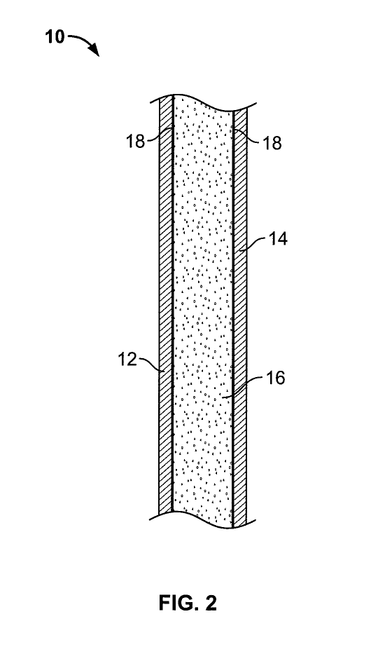

The preferred embodiment is shown in FIGS. 1 and 2. The panel 10 includes an inner layer 12 and an outer layer 14 composed of fiberglass. More specifically, each fiberglass layer essentially includes a fiber reinforcement lattice and a cured resin matrix. The two fiberglass layers are sandwiched around a foam core 16. Each of the fiberglass layers 12 and 14 are preferably about three millimeters in nominal thickness. The foam core 16 is preferably about fourteen millimeters in nominal thickness.

The panel construction does not depend on any one particular type of foam core 16; various types may be used. Foam core 16 having any of various densities may be selected depending on the specific properties desired for the panel 10. In addition, reinforced fiberglass sections, or other known reinforcing materials, may be incorporated within the foam core 16 to increase the structural strength of the panel 10.

The sandwich nature of the panel increases the strength and stiffness of the panel and does so without increasing the weight significantly over a single layer panel. Sandwich panels are composite structures formed by bonding two relatively thin outer layers to a relatively thick inner core. The outer fiberglass layers are relatively dense and resist compression while the relatively light inner foam core helps the sandwich panel resist buckling and shear loads. In contrast to a single layer panel, the sandwich construction provides better insulation, better impact resistance, and reduced noise.

The foam core material significantly reduces thermal conductivity in comparison to a single layer panel. In other words, this improved thermal conductivity results in improved heat retention in the cab and/or sleeper compartment(s). This improved heat retention allows truckers to limit or avoid idling their engines in certain cold climates, as would otherwise be required with many current panel assemblies exhibiting poor heat retention.

In addition, the panel 10 is much lighter than comparable aluminum and sheet metal panels that are commonly used. Thus, use of these lightweight panels results in a significant savings in fuel consumption and results in increased payload capacity.

Other types of core material have been used in other applications, such as balsa wood and honeycomb core. Honeycomb core usually comprises a thick sheet material, such as paper or aluminum, formed into a variety of cellular configurations, such as hexagonal cells. These cores therefore often include metal extrusions or reinforcements, internally and externally, such as aluminum alloy or steel, that are included with these panels to provide additional strength, but which also add additional weight.

These non-foam cores suffer from several additional disadvantages. They are generally much heavier than foam cores and therefore do not provide the same degree of fuel consumption or increase in payload capacity. They also absorb water and are susceptible to water degradation. Further, balsa wood cores generally have inferior fatigue resistance relative to foam cores and have a relatively short functional life. In addition, honeycomb core provides a relatively small bonding area for the outer sandwich layers, thereby producing weak bonds and making the core vulnerable to bond degradation. Processing honeycomb materials also generally involves the use of more expensive equipment and materials. Further, honeycomb core generally provides a relatively low level of thermal insulation in comparison to other types of cores.

In contrast, foam cores are easily machined and formed and may be contoured to complex curves. Also, they are available in a wide variety of densities. Accordingly, the preferred embodiment uses a foam core 16, which does not suffer from these disadvantages.

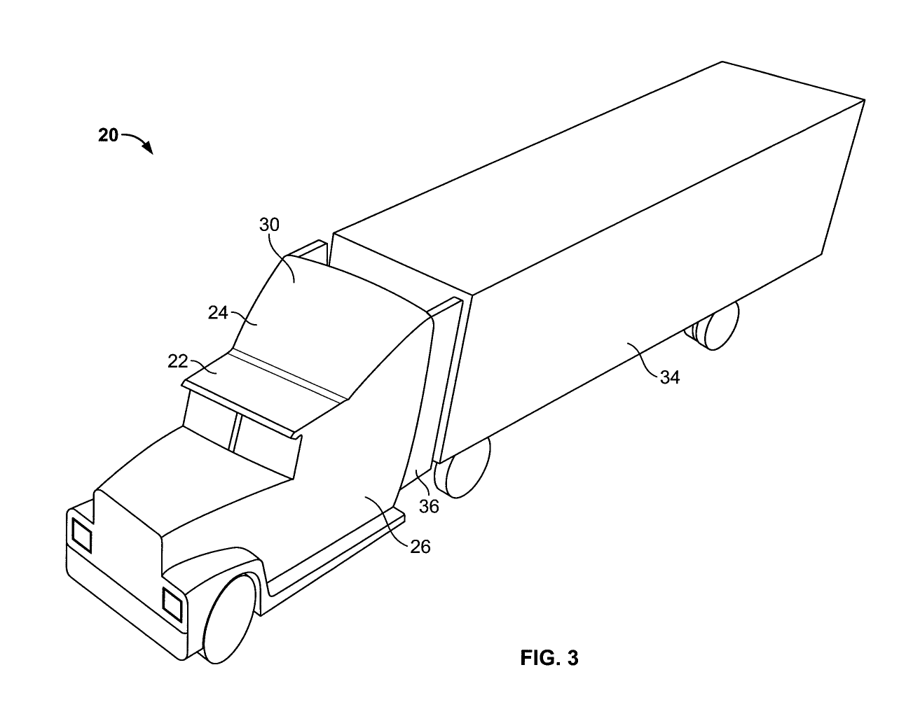

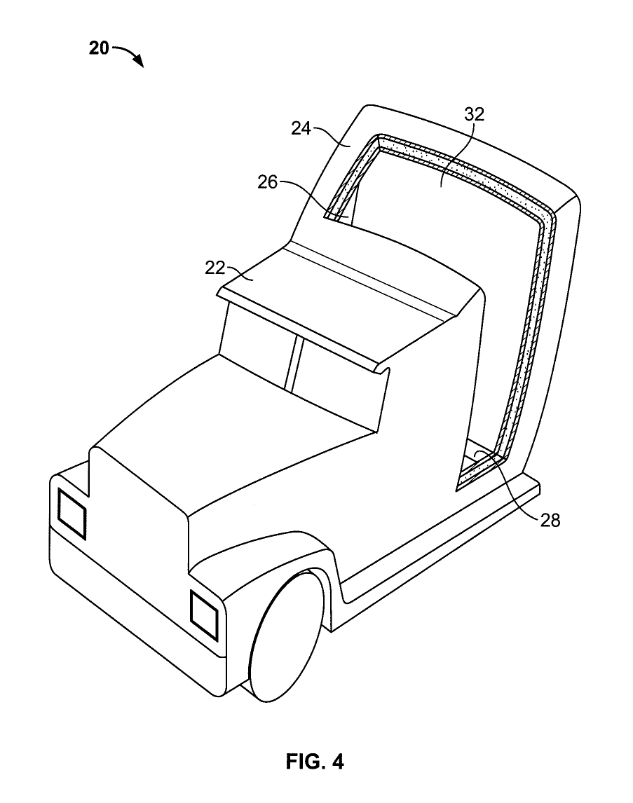

FIGS. 3-4 illustrates one embodiment of a truck 20 having a cab 22 and a sleeper box 24 composed of one or more of the structural insulation panels 10. As shown in FIGS. 3-4, the sleeper box 24 is mounted directly behind the cab 22 and is accessible to, and integral with, the cab. In other embodiments, the sleeper box 24 may constitute a separate compartment that is not integral with the cab 22.

The sleeper box 24 is defined generally by side walls 26, a floor 28, a roof cap 30, and a rear wall 32. The sleeper box 24 usually includes one or more bunk beds and electrical appliances, such as a microwave, refrigerator, and/or television, for the convenience of the operator. Structural panels 10 are preferably used for the side walls 26 and/or floor 28 of the cab 22 and sleeper box 24 and minimize the heavier conventional panels that need to be used. The side walls 26 and/or floor 28 of the cab 22 and sleeper box 24 are attached according to any one of various conventional methods.

The structural insulation panel 10 may also be formed to provide an interior trim surface for the sleeper box 24. More specifically, the panel 10 may be formed as a combination structural insulation and trim panel and may include a trim covering, such as vinyl, to provide a high quality interior wall for the sleeper box 24. Interior furnishings, such as mountings for beds or for appliances, may be mounted directly to the panel 10 according to any of various conventional mounting methods, such as through the use of conventional fasteners through mounting holes. The combination structural insulation and trim panel may be formed according to conventional injection molding technology, such as described below.

The roof cap 30 is mounted to the side walls 26 and the rear wall 32 to enclose the cab 22 and/or sleeper box 24. The roof cap 30 commonly limits the amount of air resistance or drag that would otherwise be experienced by the truck 20 during operation. More specifically, the trailer 34 hauled by the cab 22 typically includes a flat forward surface that causes significant drag during forward movement of the truck. Inclusion of the roof cap 30 allows air to be deflected around, and to thereby avoid, the flat forward surface of the trailer 34, thus minimizing air resistance significantly and reducing fuel consumption. Structural insulation panels 10 described herein may be molded, as desired, to form part or all of the roof cap 30. They provide the same structural, thermal, vibration, and acoustic advantages set forth above. The roof cap 30 may be any of various curvatures, as desired, to reduce aerodynamic drag and to provide sufficient interior space in the sleeper box 24.

As shown in FIGS. 3-4, the truck 20 also includes cab extenders 36, which are generally planar and extend rearwardly from the sleeper box 24. These cab extenders 36 also reduce the aerodynamic drag on the truck 20. More specifically, they prevent or limit the flow of air into the space between the cab/sleeper 24, 26 and the trailer 34, which would otherwise result in substantial drag. Some cab extenders 36 are fixed with respect to the sleeper box 26, while others may be manipulated manually or by a control system. The sandwich nature of the structural insulation panel 10 provides sufficient strength for such panels to be used as cab extenders 36.

It should be evident that the structural insulation panels 10 described herein are not limited to use with the truck 20 shown in FIGS. 3-4. The structural insulation panels 10 may be used with cabs and sleeper boxes that form one integral compartment or that form separate cab and sleeper compartments. In addition, they may be used in connection with all sorts of vehicles, which may or may not have sleeper boxes, roof caps, and/or cab extenders, or which may have different types of sleeper boxes, roof caps, and/or cab extenders. Further, the structural insulation panel 10 is not limited for use with cabs, sleeper boxes, roof caps, and cab extenders, but may be used to act as other inner and outer panels for trucks, which can benefit from the structural, thermal, vibration, and acoustic properties of such panels.

The structural insulation panels 10 may be formed in accordance with known closed-mold processes. The molding process is preferably conducted pursuant to an automated, computer controlled low-pressure system providing careful regulation of temperature and other variables during the molding process. In accordance with such a system, resin is injected under pressure into a closed mold containing two fiberglass reinforced mats (or plys/preforms) 18, i.e., fabrics of glass filaments or fibers, sandwiching the foam core 16. The two fiberglass mats 18 and foam core 16 are inserted into the mold, the mold is closed, and then resin, preferably polyester resin, is injected into the mold. The resin and fiberglass mats 18 bond chemically, or in other words, harden, to form two rigid and lightweight fiberglass layers 12, 14, each composed of a fiber reinforcement lattice and cured resin matrix, bonded to and sandwiching the foam core 16. Various types of resin may be used, including thermosetting polyester, vinylester, epoxy, polyurethane, or phoneolic resin.

The mold defines the configuration of the panel 10 and can be easily modified to accommodate desired changes in sizes and shapes of the panel 10. In this manner, the panel 10 can be designed and constructed of virtually any dimension and shape. For example, the panel 10 can be constructed from substantially planar molds in order to form the side walls 26 and rear wall 32 of the sleeper box 24. The panel 10 can also be constructed from a substantially planar mold to form the cab extenders 36. Alternatively, the panel 10 can be constructed from a mold having a desired curvature to form the roof cap 30.

The foregoing relates to preferred exemplary embodiments of the invention. It is understood that other embodiments and variants are possible which lie within the spirit and scope of the invention as set forth in the following claims.

What is claimed is:

1. A mobile compartment assembly comprising:
a cab defining a driver compartment, the cab defining a rear opening therein; and
a sleeper compartment disposed behind the cab and accessible from the cab by the rear opening, the sleeper including one or more panels defining, at least in part, the interior of the sleeper;
wherein at least one of the one or more panels comprises
a first fiberglass layer;
a second fiberglass layer; and
a foam core member disposed between and bonded to the first and second fiberglass layers.

2. The mobile compartment assembly of claim 1 further comprising:
a roof cap enclosing the cab and sleeper for reducing aerodynamic drag during movement of the mobile compartment, the roof cap connected to one or more panels to define, at least in part, the interior of the sleeper;
wherein the roof cap comprises:
a first fiberglass layer;
a second fiberglass layer; and
a foam core member disposed between and bonded to the first and second fiberglass layers.

3. The mobile compartment assembly of claim 1 further comprising:
one or more cab extenders for reducing aerodynamic drag during movement of the mobile compartment, the cab extenders connected to the sleeper and extending rearwardly therefrom;
wherein each cab extender comprises:
a first fiberglass layer;
a second fiberglass layer; and
a foam core member disposed between and bonded to the first and second fiberglass layers.

4. The mobile compartment assembly of claim 1 wherein the first and second fiberglass layers have a thickness ranging from approximately one to five millimeters and wherein the foam core member has a thickness ranging from approximately twelve to sixteen millimeters.

5. The mobile compartment assembly of claim 1 wherein the first and second fiberglass layers are approximately three millimeters in thickness and wherein the foam core member is approximately fourteen millimeters in thickness.

6. A sleeper module for use with a vehicle having a driver operating compartment and adapted to be mounted adjacent and behind the driver operating compartment, the sleeper module comprising:
an enclosed sleeper compartment attached to the driver operating compartment and including one or more panels defining, at least in part, the interior of the sleeper compartment;
wherein at least one of the one or more panels comprises:
a first fiberglass layer;
a second fiberglass layer; and
a foam core member disposed between and bonded to the first and second fiberglass layers.

7. The sleeper module of claim 6 further comprising:
a roof cap enclosing, at least in part, the sleeper compartment and for reducing aerodynamic drag during movement of the vehicle, the roof cap connected to one or more of the panels to define, at least in part, the interior of the sleeper compartment;
wherein the roof cap comprises:
a first fiberglass layer;
a second fiberglass layer; and
a foam core member disposed between and bonded to the first and second fiberglass layers.

8. The sleeper module of claim 6 further comprising:
one or more cab extenders for reducing aerodynamic drag during movement of the vehicle, the cab extenders connected to the sleeper compartment and extending rearwardly therefrom;
wherein each cab extender comprises:
a first fiberglass layer;
a second fiberglass layer; and
a foam core member disposed between and bonded to the first and second fiberglass layers.

9. The sleeper module of claim 6 wherein the first and second fiberglass layers have a thickness ranging from approximately one to five millimeters and wherein the foam core member has a thickness ranging from approximately twelve to sixteen millimeters.

10. The sleeper module of claim 6 wherein the first and second fiberglass layers are approximately three millimeters in thickness and wherein the foam core member is approximately fourteen millimeters in thickness.

11. A method for using a lightweight panel with structural support for a mobile compartment for individuals, the panel comprising a first fiberglass layer, a second fiberglass layer, and a foam core member disposed between and bonded to the first and second fiberglass layers, the method comprising:
enclosing and defining, at least in part, the interior of the mobile compartment with one or more panels, the one or more panels providing insulation to the interior of the mobile compartment.

12. The method of claim 11 wherein the one or more panels define, at least in part, a roof cap for reduction of aerodynamic drag caused by movement of the mobile compartment, the roof cap enclosing and defining, at least in part, the interior of the mobile compartment.

13. The method of claim 11 wherein the one or more panels define, at least in part, one or more cab extenders for reduction of aerodynamic drag caused by movement of the mobile compartment, the one or more cab extenders attached to and extending from the mobile compartment.

14. The method of claim 11 wherein the first and second fiberglass layers of each panel have a thickness ranging from approximately one to five millimeters and wherein the foam core member of each panel has a thickness ranging from approximately twelve to sixteen millimeters.

15. The method of claim 11 wherein the first and second fiberglass layers of each panel are approximately three millimeters in thickness and wherein the foam core member of each panel is approximately fourteen millimeters in thickness.

16. A lightweight panel with structural support for a mobile compartment for individuals, the panel comprising:
a first fiberglass layer,
a second fiberglass layer, and
a foam core member disposed between and bonded to the first and second fiberglass layers.

17. The lightweight panel of claim 16 wherein the first and second fiberglass layers each have a thickness ranging from approximately one to five millimeters and wherein the foam core member has a thickness ranging from approximately twelve to sixteen millimeters.

18. The lightweight panel of claim 16 wherein the first and second fiberglass layers are approximately three millimeters in thickness and wherein the foam core member is approximately fourteen millimeters in thickness.
